(19) United States
(12) Patent Application Publication
(10) Pub. No.: US 2003/0134673 A1
(43) Pub. Date: Jul. 17, 2003

(54) Slot machine with escalating symbol values

(76) Inventor: Ernest W. Moody, Las Vegas, NV (US)

Correspondence Address: JOHN EDWARD ROETHEL, 4880 W UNIVERSITY AVENUE, SUITE B3, LAS VEGAS, NV, 89103, US

(21) Appl. No.: 10/304,723

(22) Filed: Nov. 25, 2002

Related U.S. Application Data
(60) Provisional application No. 60/347,467, filed on Jan. 14, 2002.

(51) Int. Cl. A63F 9/24; A63F 13/00; G06F 17/00; G06F 19/00

(52) U.S. Cl. 463/20

(57) ABSTRACT

If the player achieves a winning combination of symbols on active pay lines, the player is provided with a second spin of the slot reels, but the first set of slot symbols are replaced with a second set of slot symbols that have higher potential payouts. If the player achieves a winning combination of symbols on active pay lines on the second spin, a third spin is offered with a third set of symbols with even higher potential payouts. As long as the player keeps winning on each successive spin, the symbols continue to be replaced with higher value symbols. Once the player loses, the symbols reset to the first symbol set. Each successive spin may be a free spin, or may require an additional wager for the successive spins, or the some of the successive spins may be free and others may be require an additional wager.

### CROSS-REFERENCE TO RELATED APPLICATION

This application is based on and claims the benefit of U.S. Provisional Application Serial No. 60/347467, filed Jan. 14, 2002, entitled “Slot Machine with Escalating Symbol Values.”

This invention relates primarily to electronic video gaming devices, and more particularly to electronic video slot machines that have symbol values that change and increase during the play of the game. While the present invention has many variations, the basic principle common to all of the variations is that whenever the player achieves a winning symbol combination, either on a pay line or as a scatter pay, the player is provided with an extra spin during which a higher value symbol set is substituted for the first symbol set. The extra spin may be a free spin or the player may be required to make an additional wager for this extra spin.

### BACKGROUND OF THE INVENTION

Reel slot machines have been used in gaming establishments for more than one hundred years. The traditional reel slot machine has three mechanical reels that rotate around a common horizontal axis. A reel strip is attached around the circumference of each slot reel and the reel strip contains a plurality of symbols thereon. As each reel comes to a stop, a symbol on the perimeter of the reel strip is displayed on a horizontal pay line on the face of the gaming machine. If the symbols that align on the pay line match one of the preselected winning combinations, the player is a winner.

Newer slot machines have been developed that have multiple pay lines—such as additional horizontal pay lines, diagonal pay lines, V-shaped pay lines, W-shaped pay lines and staggered pay lines. The number of reels have been increased beyond the basic three reel slot machines; four reels, five reels and more have been used up to the classic Big Bertha slot machine that has ten reels.

Besides using mechanical reels, slot machines have been developed that use video representations of spinning reels. One of the more popular video reel slot machines uses five reels with nine pay lines. When the video representation of the reels stop spinning, fifteen symbols are displayed to the player disposed in three horizontal rows and five vertical columns. On this three-by-five matrix formed by the three rows and five columns of symbols that are shown, multiple separate pay lines can be provided.

These multiple pay lines can take almost any configuration.

Typically, pay line #1 is the center horizontal row as shown:

[symbol]

Pay line #2 is the top horizontal row as shown:

[symbol]

Pay line #3 is the bottom horizontal row as shown:

[symbol]

After these three traditional pay lines, other pay lines can be allocated in any configuration, such as V-shaped, inverted V shaped, W-shaped, inverted W-shaped and even staggered pay lines.

A typical staggered pay line would be as shown:

[symbol]

It is also known to provide payouts that are not on a particular pay line that is selected by the player. These payouts are known as scatter pay payouts and are awarded when three or more identical symbols occur anywhere in the display matrix. A typical scatter pay award would be as shown:

[symbol]

These pay line configurations and scatter pay configurations are merely representative of any of a myriad of pay line configurations and scatter pay configurations that can be used.

A plethora of winning symbol combinations are provided so that the player has a large number of various opportunities to win depending on which symbols are displayed in which locations on the reels when the reels stop spinning.

It is an object of the present invention to provide a slot machine that operates in a manner in which the player can receive increased payouts as the game progresses.

It is a feature of the present invention that the symbols used to indicate winning combinations increase in value for each spin of the reels following a spin that results in a winning combination. The player may receive these additional spins using symbols having higher values either as free spins or as spins for which the player must make an additional wager.

It is an advantage of the present invention that a player may receive increased payouts when the player achieves winning combinations on consecutive spins of the reels. This allows the player to achieve higher and higher payouts when the player has a run of good luck and achieves winning symbol combinations on two or more spins in a row.

Other objects, features and advantages of the present invention will become apparent from a consideration of the following detailed description.

### SUMMARY OF THE INVENTION

A player makes a wager for each pay line on a slot machine that the player wishes to play. In the preferred embodiment, the slot machine has multiple reels with multiple rows, such as a five reel machine with a three row display. One or more pay lines can be used. A first set of slot symbols are used for the first spin of the reels.

If the player achieves a winning combination of symbols on one or more active pay lines, the player is provided with a second spin of the slot reels, but this time the first set of slot symbols have been replaced with a second set of slot symbols that have higher potential payouts. This second spin of the slot reels can be a free spin or the player can be required to make an additional wager for this second spin.

Again, if the player achieves a winning combination of symbols on one or more pay lines on the second spin, a third spin is offered with a third set of symbols with even higher potential payouts. As long as the player keeps winning on each successive spin, the symbols continue to be replaced with higher value symbols. Once the player loses, the symbols reset to the first symbol set. Each successive spin may be a free spin, or the player may be required to make an additional wager for the successive spins or the some of the successive spins may be free and others may be require an additional wager.

### BRIEF DESCRIPTION OF THE DRAWINGS

FIG. 1 shows the screen display of the slot reels of the present invention after the player has made the initial spin of the reels with the symbols from the first symbol set displayed.

FIG. 2 shows the screen display of the slot reels of the present invention after the player has made the second spin of the reels with the symbols from the second symbol set displayed.

FIG. 3 shows the screen display of the slot reels of the present invention after the player has made the third spin of the reels with the symbols from the third symbol set displayed.

FIG. 4 shows the screen display of the slot reels of the present invention after the player has made the fourth spin of the reels with the symbols from the fourth symbol set displayed.

### DETAILED DESCRIPTION OF THE PREFERRED EMBODIMENTS

The present invention involves a method of operating an electronic video slot machine in which the symbols on the reels increase in value after every winning spin of the slot reels.

An electronic video slot machine of the present invention is programmed to display multiple pay lines with each pay line displaying a reel symbol associated with each reel location. The present invention includes plurality of reel symbols that can be displayed on each reel location on the video display of the video slot machine. A first group of reel symbols are used for the first spin of the reels. If the player achieves a winning symbol combination on the first spin of the reels, a second set of reel symbols having a higher value are used for the second spin of the reels. For each consecutive spin of the reels that results in a winning symbol combination, another set of reel symbols are used having increasing values. Once the player spins the reels and has no winning symbol combinations, the video slot machine resets to the first group of reel symbols.

Alternatively, when a player achieves a losing spin, the video slot machine could be reset to one of the previous groups of reel symbols rather than all the way back to the first group of reel symbols. The resetting of the video slot machine to one of the previous groups of reel symbols could be either on a preselected schedule or randomly.

In the method of play of the present invention, a player makes a wager for each pay line on a slot machine that the player wishes to play. In the preferred embodiment, the slot machine has multiple reels with multiple rows, such as five reels with a three row display as shown in the drawings. One or more pay lines can be used. Each coin, token or credit wagered by the player activates in a predetermined, sequential order the various pay lines. For example, if the video slot machine has nine pay lines available, the player must wager nine coins to activate all nine pay lines with one coin on each line. A maximum of five credits is usually allowed (although other gaming machines of this type can have a maximum number of credits less than five or more than five up to as many as twenty per pay line) on each pay line, so the maximum wager by the player would be forty-five credits.

A first group of slot symbols are used for the first spin of the reels. These slot symbols can be any quantity having any values for achieving winning symbol combinations. Any suitable types of winning symbol combinations can be used and the video slot machine would include a pay table to apprise the player of which symbol combinations award which amounts.

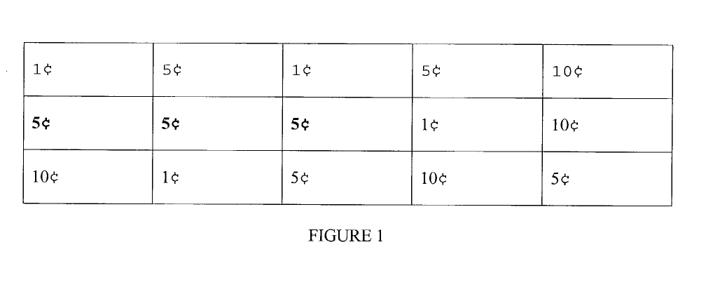

For example, as shown in FIG. 1, the reel symbols include a 1¢ symbol, a 5¢ symbol and a 10¢ symbol. In order to achieve a winning combination, the player must achieve at least three of the same reel symbols on adjoining reel locations an active pay line upon which the player has made a wager. As shown in FIG. 1, the player has achieved three 5¢ symbols on adjoining reel locations which means the player would be awarded 5¢ times the number of credits wagered on the center pay line. If the player had wagered five credits on the center pay line, the player would have won 25¢.

If the player achieves a winning combination of symbols on one or more active pay lines, the player is provided with a second spin of the slot reels, but this time the first set of slot symbols have been replaced with a second set of slot symbols that have higher potential payouts. This second spin of the slot reels can be a free spin or the player can be required to make an additional wager for this second spin.

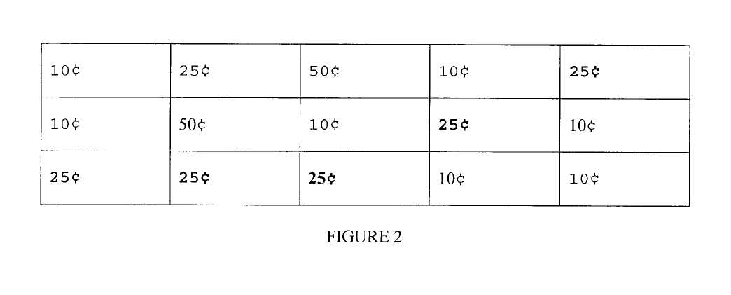

For example, as shown in FIG. 2, after the player achieved a winning symbol combination on the first spin of the reels shown in FIG. 1, a second group of reel symbols are used for the next spin of the reels. As shown in FIG. 2, the second group of reel symbols can include a 10¢ symbol, a 25¢ symbol and a 50¢ symbol. When the player makes the second spin of the reels, the player could achieve the reel symbol distribution shown in FIG. 2. In this example, the player would achieve a winning symbol combination of five 25¢ symbols along a staggered pay line. The player would be awarded 25¢ times the number of credits wagered on the center pay line. If the player had wagered five credits on the center pay line, the player would have won $1.25.

Since the player has achieved a winning combination of symbols on one of the pay lines on the second spin of the reels, a third spin is offered with a third set of symbols with even higher potential payouts. As happened before, the second set of slot symbols have been replaced with a third set of slot symbols that have even higher potential payouts. This third spin of the slot reels can be a free spin or the player can be required to make an additional wager for this third spin.

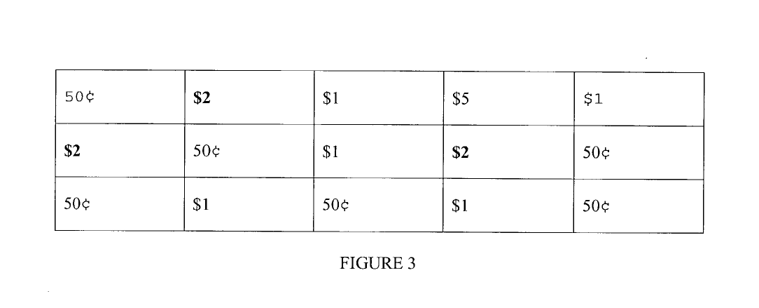

For example, as shown in FIG. 3, after the player achieved a winning symbol combination on the second spin of the reels shown in FIG. 2, a third group of reel symbols are used for the next spin of the reels. As shown in FIG. 3, the third group of reel symbols can include a 50¢ symbol, a $1 symbol, a $2 symbol and a $5 symbol. When the player makes the third spin of the reels, the player could achieve the reel symbol distribution shown in FIG. 3. In this example, the player would achieve a winning symbol combination of three $2 symbols as a scatter pay award. The player would be awarded $2 times the total number of credits wagered on all of the pay lines. If the player had wagered five credits on each of nine pay lines for a total wager of forty-five credits, the player would have won $90.00.

Since the player has achieved a winning combination of symbols, even as a scatter pay award as in the case of FIG. 3, a fourth spin is offered with a fourth set of symbols with even higher potential payouts. Again as happened before, the third set of slot symbols have been replaced with a fourth set of slot symbols that have even higher potential payouts. This fourth spin of the slot reels can be a free spin or the player can be required to make an additional wager for this fourth spin.

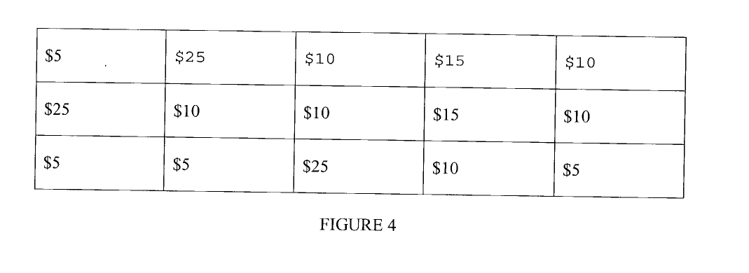

For example, as shown in FIG. 4, after the player achieved a winning symbol combination on the third spin of the reels shown in FIG. 3, a fourth group of reel symbols are used for the next spin of the reels. As shown in FIG. 4, the fourth group of reel symbols can include a $5 symbol, a $10 symbol, a $15 symbol and a $25 symbol. When the player makes the fourth spin of the reels, the player could achieve the reel symbol distribution shown in FIG. 4. In this example, the player would achieve no winning symbol combinations either on a pay line or as a scatter pay award. The player would lose all of his wagers and the video slot machine would reset to the first group of reel symbols for the next play of the game.

Alternatively, the video slot machine could be reset to one of the previous groups of reel symbols rather than all the way back to the first group of reel symbols. For example, the video slot machine could be reset to either the first group of reel symbols, the second group of reel symbols or the third group of slot symbols. The resetting of the video slot machine to one of the previous groups of reel symbols could be either on a preselected schedule or randomly.

In a preferred embodiment of the present invention, as long as the player keeps winning on each successive spin, the reel symbols continue to be replaced with higher value group of reel symbols. Alternatively, after a pre-established number of winning spins (say five or ten consecutive winning spins), the highest value group of reel symbols would continue to be used until the player had a losing spin of the reels.

Each successive spin may be a free spin, or the player may be required to make an additional wager for the successive spins or the some of the successive spins may be free and others may be require an additional wager.

Any suitable groups of pay tables can be used; with the winning amounts and symbol combinations being based on the mathematical return desired to be provided on the gaming machine.

One or more symbols may also be designated as wild symbols. Wild symbols increase the possibility of player achieving winning combinations and the pay table should be adjusted to reflect that wild symbols are in use.

The number of pay lines employed in the present invention is also not critical. More or less than five pay lines can be used.

While the invention has been illustrated with respect to several specific embodiments thereof, these embodiments should be considered as illustrative rather than limiting. Various modifications and additions may be made and will be apparent to those skilled in the art. Accordingly, the invention should not be limited by the foregoing description, but rather should be defined only by the following claims.

What is claimed is:

1. A method of playing a slot machine having a plurality of slot reels with symbols associated therewith and having at least one pay line comprising:
a) providing a first group of slot symbols associated with a pay table;
b) activating the slot machine and determining if a winning combination of symbols has been achieved on a pay line;
c) if a winning combination has been achieved, providing the player with an award and providing a second, different group of slot symbols associated with the pay table; and
d) activating the slot machine and determining if a winning combination of symbols has been achieved on a pay line.

2. The method of claim 1 including making a wager to be eligible to play the slot machine.

3. The method of claim 1 including making a first wager which is associated with the first group of slot symbols and making a second wager which is associated with the second group of slot symbols.

4. A method of playing a slot machine having a plurality of slot reels with symbols associated therewith and having at least one pay line comprising:
a) providing a first group of slot symbols associated with a pay table;
b) activating the slot machine and determining if a winning combination of symbols has been achieved on a pay line;
c) if a winning combination has been achieved, providing the player with an award and providing a second, different group of slot symbols associated with the pay table;
d) activating the slot machine and determining if a winning combination of symbols has been achieved on a pay line;
e) if a winning combination has been achieved, providing the player with an award and providing a third, different group of slot symbols associated with the pay table; and
f) activating the slot machine and determining if a winning combination of symbols has been achieved on a pay line.

5. The method of claim 4 including making a wager to be eligible to play the slot machine.

6. The method of claim 4 including making a first wager which is associated with the first group of slot symbols, making a second wager which is associated with the second group of slot symbols; and making a third wager which is associated with the third group of slot symbols.

7. A method of playing a slot machine having a plurality of slot reels with symbols associated therewith and having at least one pay line comprising:
a) providing a first group of slot symbols associated with a pay table;
b) activating the slot machine and determining if a winning combination of symbols has been achieved on a pay line;
c) if a winning combination has been achieved, providing the player with an award and providing a second, different group of slot symbols associated with the pay table;
d) activating the slot machine and determining if a winning combination of symbols has been achieved on a pay line;
e) continuing to provide the player with an award and continuing to provide additional, different groups of slot symbols as long as the player achieves a winning combination on a pay line.

8. The method of claim 7 including making a wager to be eligible to play the slot machine.

9. The method of claim 7 including making a first wager which is associated with the first group of slot symbols and making additional wagers which are associated with each additional group of slot symbols.

10. A method of playing a slot machine comprising:
a) providing a first pay table for winning combinations on the slot machine;
b) activating the slot machine and determining whether at least one winning combination has been achieved; and
c) if a winning combination as been achieved, providing a second different pay table for a next play of the slot machine.

11. The method of claim 10 including making a wager to be eligible to play the slot machine.
